(19) United States
(12) Patent Application Publication
(10) Pub. No.: US 2017/0097893 A1
(43) Pub. Date: Apr. 6, 2017

(54) SYSTEMS AND METHODS FOR TAPE DATA ACCESS

(71) Applicant: Tridib Chakravarty, Irvine, CA (US)

(72) Inventor: Tridib Chakravarty, Irvine, CA (US)

(21) Appl. No.: 15/284,069

(22) Filed: Oct. 3, 2016

Related U.S. Application Data
(60) Provisional application No. 62/236,093, filed on Oct. 1, 2015.

(51) Int. Cl. G06F 12/0873

(52) U.S. Cl. CPC G06F 12/0873; G06F 2212/1008; G06F 2212/213

(57) ABSTRACT

Retrieval of files containing audiovisual information from tape may be accelerated by reading from tape metadata in the files, storing the metadata in cache memory, and subsequently reading the file from tape, with reads of the metadata fulfilled from the cache. In some embodiments a memory map of objects in the file is created when the file is written to tape, and utilized to determine metadata locations in the file when reading the metadata to store in the cache.

### CROSS REFERENCE TO RELATED APPLICATIONS

This application claims the benefit of the filing date of U.S. Provisional Patent Application No. 62/236,093, filed on Oct. 1, 2015, the disclosure of which is incorporated by reference herein.

### BACKGROUND OF THE INVENTION

The present invention generally relates to tape storage of media files, and more particularly relates to recovery of media files stored on tape.

Media information, whether audio information, video information, or audiovisual information, is often stored in digital format. Digital media files, however, are often very large, consuming significant computer storage space. As long term storage of such files in on-board computer memory or even on computer hard drives may be costly, at least for substantial quantities of material, the files are often stored on magnetic tape. Unfortunately, storage of files on tape may pose difficulties when access to the digital media files is desired. Access to the digital media files may be desired for any number of reasons, including for editing, for transcoding, for scene or shot retrieval, or for distribution.

Tapes in compliance with Linear Tape Open (LTO) technology may be used, decreasing possibility of differing hardware components being able to read a particular tape. In addition, data may be written to tape using a Linear Tape File System (LTFS) format, which generally allows data in tapes to be accessed using a file system format.

While using such tapes and taking such actions may reduce inconveniences in retrieving data from tape, retrieval of the data may still take excessive time considering that files retrieved may be relatively large. In addition, this time may be increased, and perhaps increased dramatically, if the files themselves have complex layouts, which may result in non-sequential reading of data from tape.

### BRIEF SUMMARY OF THE INVENTION

Aspects of the invention relate to acceleration of audiovisual file retrieval from tape. In some aspects of embodiments of the invention, a file containing audiovisual information is written to tape, a memory map, indicating locations of objects within the file, is stored, and, for retrieval of the file from tape, the memory map is accessed to determine locations of metadata within the file, the metadata is read from the tape and stored in cache memory, and the file as a whole is read, with accesses to audiovisual information of the file fulfilled from the tape and accesses to the metadata fulfilled from the cache memory.

These and other aspects of the invention are more fully comprehended upon review of this disclosure.

### BRIEF DESCRIPTION OF THE FIGURES

FIG. 1 is a block diagram of a system in accordance with aspects of the invention.

FIG. 2 illustrates an example layout of a file for audiovisual information as stored on tape.

FIG. 3 illustrates another example layout of a file for audiovisual information.

FIG. 4 illustrates another example layout of a file for audiovisual information.

FIG. 5 is a block diagram of a further embodiment of a system in accordance with aspects of the invention.

FIG. 6 is a flowchart of a process in accordance with aspects of the invention.

FIG. 7 is a flowchart of a process associated with writing a file to tape in accordance with aspects of the invention.

FIG. 8 is a flowchart of a process associated with retrieving a file from tape in accordance with aspects of the invention.

FIG. 9 is a flowchart of a process associated with retrieving a file from tape in accordance with aspects of the invention.

### DETAILED DESCRIPTION

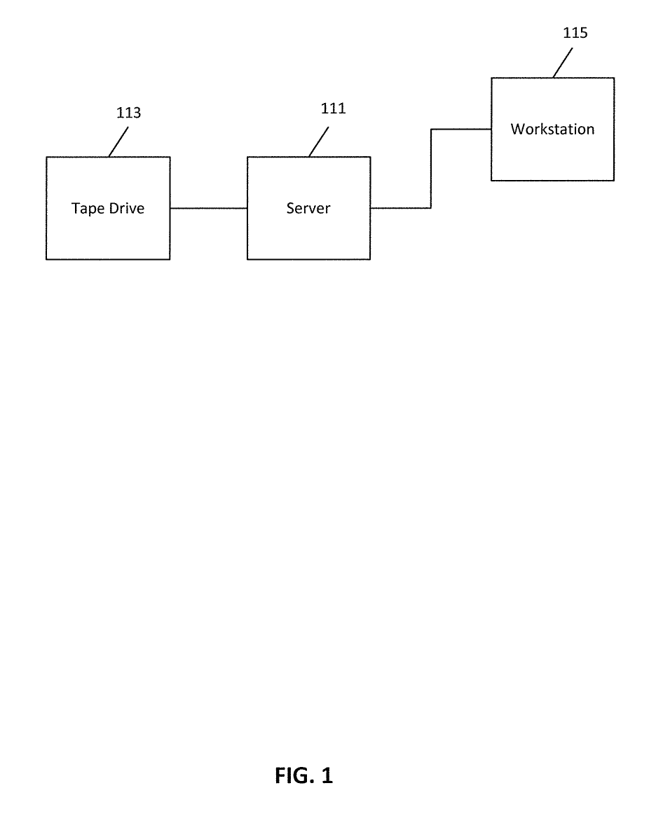

FIG. 1 is a block diagram of a system in accordance with aspects of the invention. In FIG. 1, a workstation 115 is coupled to a server 111, which controls operation of a tape drive 113. The workstation generally includes one or more processors, memory, and input/output (I/O) devices, including one or more display devices. In some embodiments the workstation may be, example, a personal computer. Generally the processors of the workstation are programmed by program instructions to perform audiovisual data transformation and/or editing functions. The server also generally includes one or more processors, memory, and I/O devices, of which the tape drive may be considered one. In some embodiments the processors of the server may also or instead be programmed by program instructions to perform audiovisual data transformation and/or editing functions, in which case the workstation may be omitted from the system. The tape drive provides access to at least one tape. In various embodiments the tape drive is an LTO compliant tape drive, preferably an LTO-6 compliant tape drive. Preferably, tapes accessed by the tape drive are formatted to support file operations, and for example such tapes may be LTFS formatted tapes.

In operation, the workstation may have audiovisual information, for example of a movie, stored in memory. The audiovisual information may be stored in memory as a file. The audiovisual information generally includes video information, audio information, and metadata relating to the video information and the audio information. In some embodiments, however, the audiovisual information may omit one or the other of the video information or the audio information, although for simplicity of exposition the term “audiovisual” shall be used to refer to all or any of “audiovisual,” “audio,” or “video,” herein, unless the context indicates otherwise. In operation, it may be desirable to store the audiovisual information to tape. Conversely, in operation it may also be desirable to retrieve audiovisual from tape, for example to allow for operations by the workstation relating to the audiovisual information. Preferably, the audiovisual information is stored as a file.

In accordance with aspects of the information, the workstation may command storage of the audiovisual information to tape, with the workstation for example sending the audiovisual information, and a command to store the audiovisual information on tape, to the server. When performing such an operation, or more generally upon completion of such an operation and prior to deleting the audiovisual information from local storage, the workstation reads the file containing audiovisual information from local storage, and creates a memory map of the file containing the audiovisual information. The memory map includes, in various embodiments, information regarding offset locations, within the file, of objects in the file. For example, the file may include multiple audiovisual information objects, and, interspersed between the audiovisual information objects, metadata, for example in the form of headers and footers to the audiovisual information objects. In some embodiments the workstation stores the memory map in local memory, for later use. In some embodiments the workstation, in addition or instead, sends the memory map to the server, which may store the memory map on the same tape(s) as the file containing audiovisual information and/or in memory associated with the server and available to a plurality of workstations.

Also in accordance with aspects of the information, the workstation may command retrieval of the file containing audiovisual information from tape, for example to perform transcoding of the audiovisual information or some other operation. Prior to commanding retrieval the workstation accesses the memory map for the audiovisual information, from local memory if there stored, or by way of accessing memory of the server or by reading the memory map from tape. The workstation accesses the memory map to determine offsets of metadata within the file containing the audiovisual information, and the workstation commands reading of the metadata from the tape. In most embodiments the metadata is read by commanding a read of a section of the tape beginning at each of the offsets for the metadata. In some embodiments the workstation stores the metadata in cache memory of the workstation. In some embodiments storage of the metadata in the cache is a result of reading of the metadata. In some embodiments the workstation explicitly commands the metadata to be stored in the cache. The workstation thereafter commands reading of the file of the audiovisual information from tape, with reading of the metadata fulfilled from the cache of the workstation, instead of from the tape.

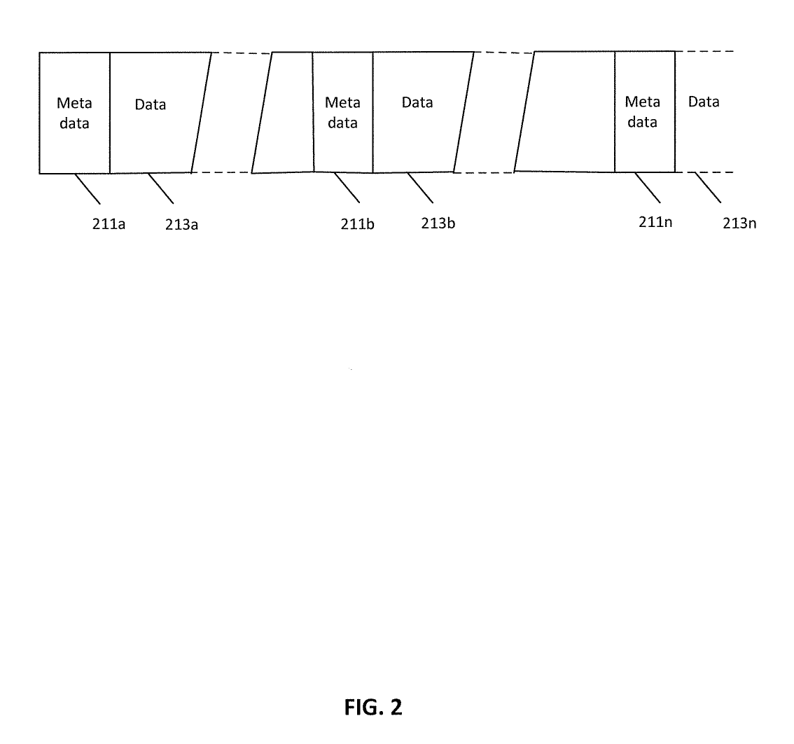

FIG. 2 illustrates an example layout of a file containing audiovisual information as stored on tape. The file includes a plurality of blocks of metadata 211a-n, and a plurality of blocks of audiovisual data 213a-n. As illustrated in FIG. 2, the blocks are arranged sequentially on tape. In some embodiments the blocks may be arranged on tape in a discontinuous manner. The metadata generally includes information about the audiovisual data. The audiovisual data generally includes information for generating frames of video for display and/or audio information for aural presentation. In general the blocks of audiovisual data are much larger than the blocks of metadata. For example, in some embodiments each block of audiovisual data is at least one thousand times larger than each block of metadata. At times, the audiovisual data may be termed essence data, considering that the “essence” of audiovisual information comprises, or in some embodiments consists of, audiovisual data for visual and aural presentation. In general, blocks of metadata are dispersed between blocks of audiovisual data. In some embodiments at least one block of metadata is between any two blocks of audiovisual data. In some embodiments each block of audiovisual data is preceded by a header block of metadata. In some embodiments each block of audiovisual data is succeeded by a footer block of metadata. In some embodiments each block of audiovisual data is preceded by a header block of metadata and succeeded by a footer block of metadata.

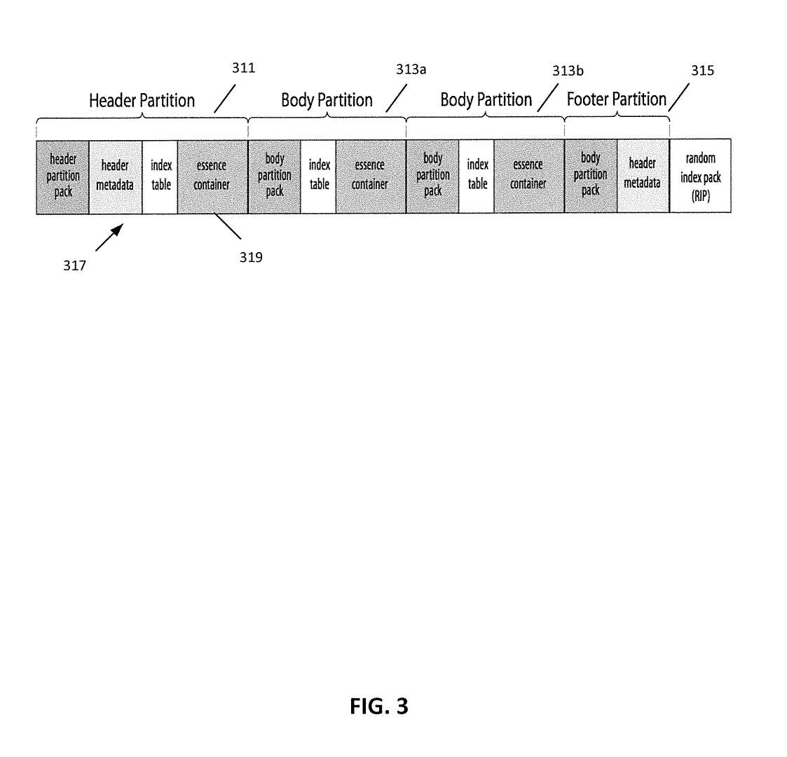

FIG. 3 illustrates another example layout of a file containing audiovisual information. In the example of FIG. 3, the file includes a header partition 311, a plurality of body partitions (with two body partitions 313a,b illustrated in FIG. 3), and a footer partition 315. Using the header partition as an example, the partition includes metadata 317 comprising a header partition pack, header metadata, and an index table. The header partition also includes an essence container 319, which stores audiovisual data. In general, the essence container is significantly larger than a combination of the header partition pack, header metadata, and index table, and in some embodiments may be at least one thousand times larger.

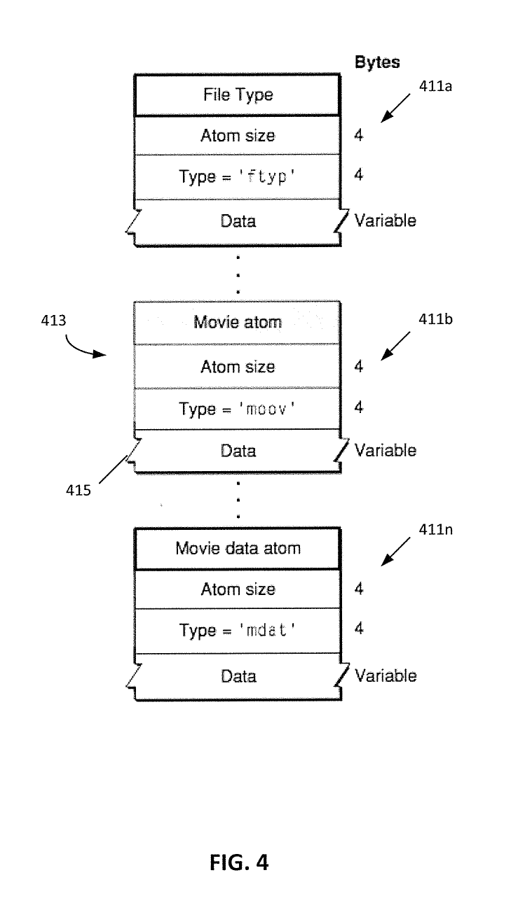

FIG. 4 illustrates another example layout of a file containing audiovisual information. In the example of FIG. 4, the file includes a plurality of portions 411a-n. Each of the portions, taking the portion 411b as an example, includes metadata 413 and audiovisual data 415. The metadata 413, as illustrated in FIG. 4, includes movie atom data.

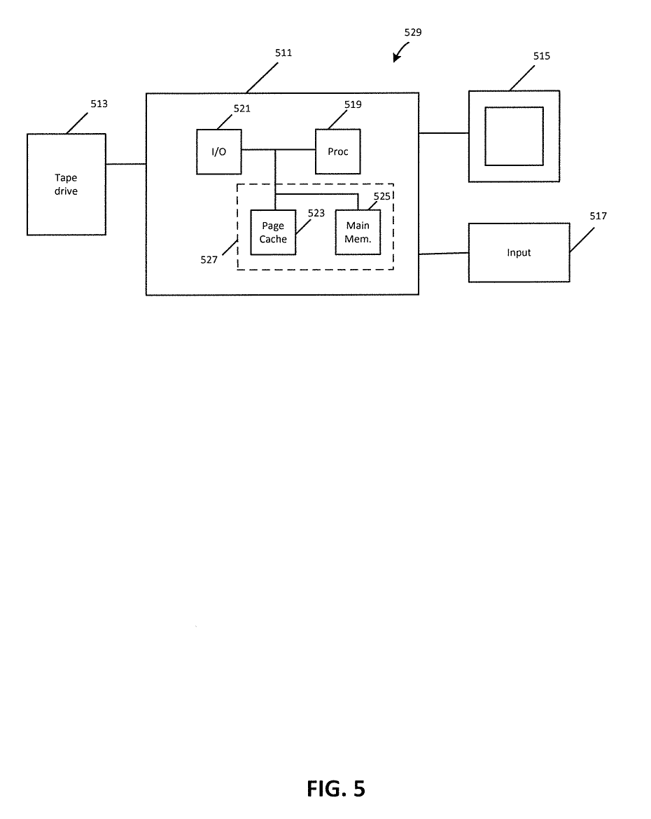

FIG. 5 is a block diagram of a further embodiment of a system in accordance with aspects of the invention. In the embodiment of FIG. 5, a workstation 529 is coupled to a tape drive 513. The workstation includes a display device 515, a user input device 517, and a housing 511 for computer hardware, including a processor 519, I/O circuitry 521, and memory 527. The memory includes a main memory 525 and a page cache 523. In some embodiments the page cache may be part of the main memory. In some embodiments the memory may also include additional storage, for example a storage device such as a hard drive, disk drive, or other electronic or electromagnetic storage device. The processor is preferably programmed by program instructions stored in the memory to perform processing of audiovisual information, for example transcoding or video editing. The processor is also programmed by program instructions stored in the memory to command writing and reading of files containing audiovisual information to a tape in the tape drive. In some embodiments the tape drive may be connected directly to the workstation, as illustrated in FIG. 5, but in various embodiments the tape drive may be accessible to the workstation over a network, for example a local area network or alternatively a wide area network, for example the Internet. In most embodiments the tape is a LTO tape, for example LTO-5 or LTO-6, supporting a Linear Tape File System (LTFS).

In operation, when commanding writing of a file containing audiovisual information to the tape, the processor creates a memory map of objects within the file. The objects may be for example, audiovisual information and metadata concerning the audiovisual information. In most embodiments the memory map specifies objects and an offset value indicating their position in the file. In some embodiments the processor writes the memory map to memory of the workstation. In some embodiments the processor, in addition or instead, commands writing of the memory map to network accessible memory. In some embodiments the processor creates the memory map prior to commanding writing of the file to tape. In some embodiments, and generally more conveniently, the processor creates the memory map upon completion of writing the file to tape, while the file remains in memory of the workstation. In some embodiments the processor additionally, or instead, commands writing of the memory map to the tape.

When commanding reading of a file containing audiovisual information from the tape, the processor reads a memory map of objects within the file. The memory map may be stored locally at the workstation, for example if the workstation commanded writing of the file to tape, or the memory map may be read from a shared memory, for example accessible over a network. In some embodiments the processor may command reading of the memory map from the tape.

In commanding read of the file containing audiovisual information from the tape, the processor first commands reading of segments of the tape. Each of the segments begins at a tape position indicated by an offset in the memory map associated with metadata in the file. The processor stores information of the segments in the memory cache of the workstation. In some embodiments the information of the segments is stored in a normal course of operation of the processor in obtaining information of the segments from the tape. In some embodiments the processor is programmed to explicitly command storage of the information of the segments in the cache.

During reading of the file containing audiovisual information from the tape, audiovisual data is read from the tape. During reading of the audiovisual data, metadata is also to be accessed. As the metadata is already stored in the cache of the workstation, however, accesses to the metadata are to the metadata in the cache, rather than rereading the metadata from the tape. In some embodiments, reading of the file from the tape is significantly faster as multiple seeks to the metadata during reading of the file may be avoided.

In some embodiments, after reading the file, the workstation performs a process on the audiovisual information. In some embodiments the process is transcoding of the audiovisual information. In some embodiments the process is performance of video editing operations on the audiovisual information.

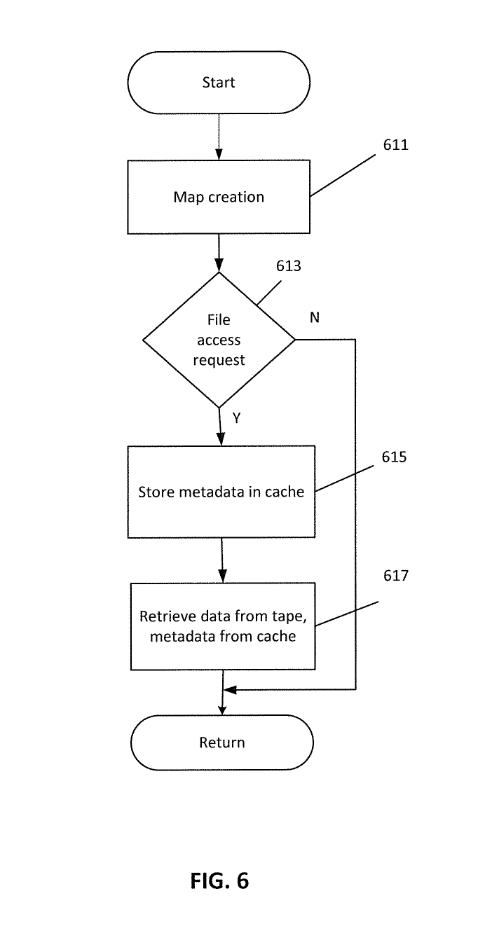

FIG. 6 is a flowchart of a process in accordance with aspects of the invention. In some embodiments the process is performed by a system as discussed with respect to FIG. 1 or 5. In some embodiments the process is performed by a workstation, for example as discussed with respect to FIG. 1 or 5. In some embodiments the process is performed by a processor, for example as programmed by program instructions.

In block 611 the process creates a memory map of an audiovisual file. In some embodiments the memory map specifies locations of metadata in the file. In some embodiments the locations are specified as an offset from a beginning of the file. In some embodiments the offsets are specified as a number of bytes. In some embodiments the memory map specifies locations of objects in the file. In some embodiments the objects include metadata and audio/video essence data.

In block 613 the process determines if access to an audiovisual file on tape is requested. If so, the process continues to block 615, otherwise the process returns.

In block 615 the process stores metadata of the file on tape in cache memory of a workstation. In some embodiments the process determines locations of the metadata on the tape using the memory map. In some embodiments the process commands reads of segments of tape beginning at locations of the metadata on tape. In some embodiments the process stores the metadata in the cache memory as part of a process of reading the metadata from the tape. In some embodiments the process explicitly commands storage of the metadata in the cache memory.

In block 617 the process retrieves audiovisual information of the file from tape, with the process retrieving metadata of the file from cache memory. In some embodiments, the process retrieves a plurality of objects of audiovisual information from the tape, with retrieval of metadata, in the context of retrieving the objects of audiovisual information, fulfilled by reading the metadata from the memory cache.

The process thereafter returns.

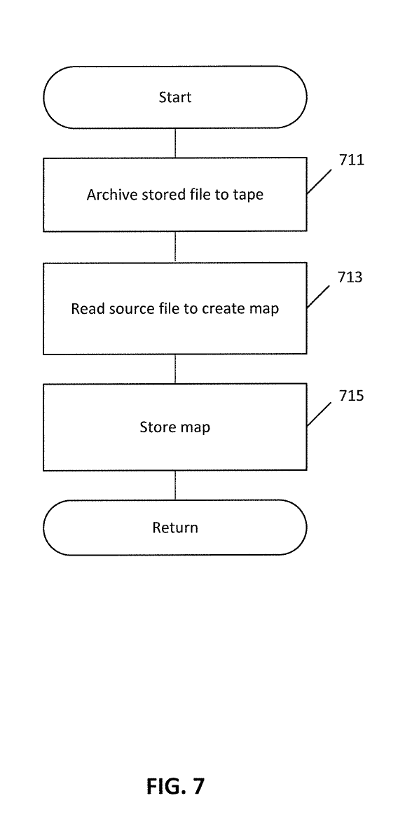

FIG. 7 is a flowchart of a process associated with writing a file to tape in accordance with aspects of the invention. In some embodiments the process is performed by a system as discussed with respect to FIG. 1 or 5. In some embodiments the process is performed by a workstation, for example as discussed with respect to FIG. 1 or 5. In some embodiments the process is performed by a processor, for example as programmed by program instructions. In some embodiments the process performs operations of block 611 of the process of FIG. 6.

In block 711 the process archives a file containing audiovisual information to tape. In some embodiments the tape is an LTO-compliant tape implementing an LTFS. In some embodiments a workstation contains the file in local storage of the workstation, and the workstation commands writing of the file to the tape. In some embodiments a tape drive writes the file to tape.

In block 713 the file is read to create a memory map of objects in the file. In some embodiments the file is stored in local storage of the workstation. In some embodiments the memory map specifies objects in the file and values indicative of locations of the objects in the file. In some embodiments the values indicative of locations in the file are offsets. In some embodiments the offsets are offsets from a first byte of the file. In some embodiments the objects are arranged sequentially in the file, and the offsets, other than possibly a first offset, are indicative of location from a beginning location of a prior object in the file.

In block 715 the process stores the memory map. In some embodiments the memory map is stored in local memory of the workstation. In some embodiments the memory map is stored in memory of a network device. In some embodiments the memory map is stored by writing the memory map to tape, which in some embodiments is the same tape to which the file was written.

The process thereafter returns.

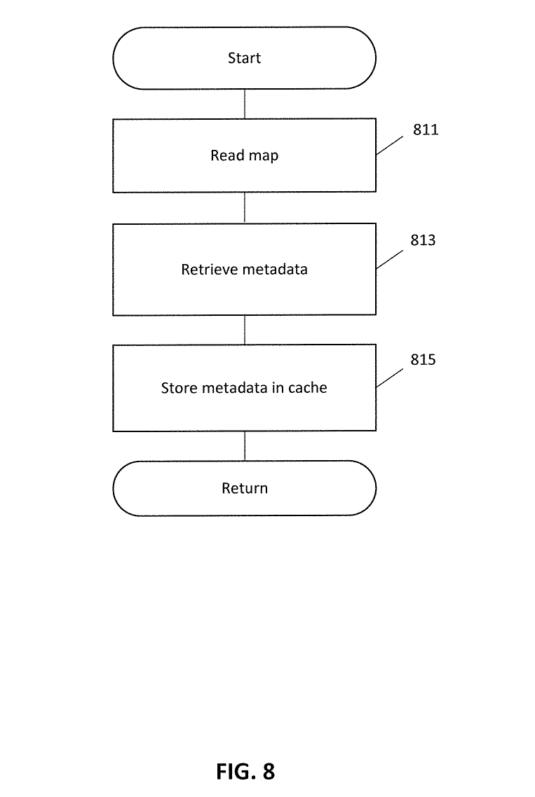

FIG. 8 is a flowchart of a process associated with retrieving a file from tape in accordance with aspects of the invention. In some embodiments the process is performed by a system as discussed with respect to FIG. 1 or 5. In some embodiments the process is performed by a workstation, for example as discussed with respect to FIG. 1 or 5. In some embodiments the process is performed by a processor, for example as programmed by program instructions. In some embodiments the process performs operations of block 615 of the process of FIG. 6.

In block 811 the process reads a memory map for a file stored on tape. In some embodiments the memory map is stored in local memory of the workstation. In some embodiments the memory map is stored on a network accessible storage device. In some embodiments the memory map is stored on the tape. In various embodiments the memory map indicates locations of objects stored on the tape. In some embodiments the objects include audiovisual information and metadata.

In block 813 the process retrieves the metadata from the tape.

In block 815 the process stores the metadata in cache memory of the workstation.

The process thereafter returns.

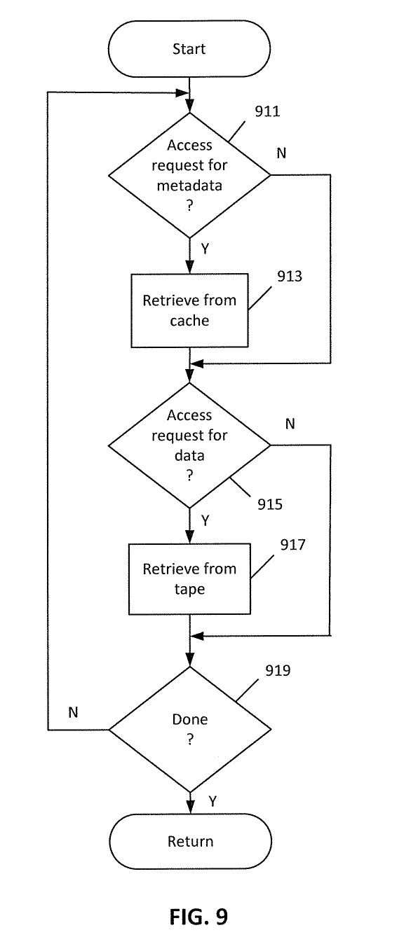

FIG. 9 is a flowchart of a process associated with retrieving a file from tape in accordance with aspects of the invention. In some embodiments the process is performed by a system as discussed with respect to FIG. 1 or 5. In some embodiments the process is performed by a workstation, for example as discussed with respect to FIG. 1 or 5. In some embodiments the process is performed by a processor, for example as programmed by program instructions. In some embodiments the process performs operations of block 617 of the process of FIG. 6.

In block 911 the process determines if an access request for information stored on tape is for metadata of a file being read from the tape. If so, the process continues to block 913, otherwise the process goes to block 915.

In block 913 the process retrieves the metadata from cache memory and stores the metadata in local memory. In some embodiments the cache memory is cache memory of a workstation requesting reading of the file from tape.

In block 915 the process determines if the access request for information stored on tape is for audiovisual information of the file being read from tape. If so, the process continues to block 917, otherwise the process goes to block 919.

In block 917 the process retrieves the audiovisual information from the tape and stores the audiovisual information in local memory.

In block 919 the process determines if reading of the file is complete. If not, the process goes to block 911. Otherwise the process returns.

Although the invention has been discussed with respect to various embodiments, it should be recognized that the invention comprises the novel and non-obvious claims supported by this disclosure.

What is claimed is:

1. A method useful in relation to processing of files containing audiovisual information, comprising:
storing a memory map of objects or items of a file containing audiovisual information;
commanding reads of portions of a tape storing metadata in the file containing audiovisual information;
placing the metadata in a cache memory;
commanding reading of the file containing audiovisual information from the tape, with commanded reads of the metadata fulfilled from cache memory.

2. The method of claim 1, wherein the memory map is stored on the tape.

3. The method of claim 1, wherein the memory map is stored in memory of a computer preforming commanding reads of portions of the tape storing the metadata in the file containing audiovisual information and commanding reading of the file containing audiovisual information from the tape.

4. The method of claim 1, further comprising commanding writing of the file containing audiovisual information to the tape.

5. The method of claim 1, wherein the memory map is used in commanding reads of portions of the tape storing metadata in the file containing audiovisual information.

6. The method of claim 5, wherein the memory map includes offsets indicating positions of metadata in the file containing audiovisual information.

7. The method of claim 1, wherein the audiovisual information in the file is at least one thousand times larger than the metadata in the file.

8. The method of claim 7, wherein at least one block of metadata is between any two blocks of audiovisual data in the file.

9. The method of claim 1, further comprising transcoding the audiovisual information in the file.

10. The method of claim 1, further comprising performing video editing operations on the audiovisual information in the file.
